(19) United States
(12) Patent Application Publication
(10) Pub. No.: US 2012/0192216 A1
(43) Pub. Date: Jul. 26, 2012

(54) QOE ENSURING METHOD AND APPARATUS

(75) Inventors: Bing CHEN, Shenzhen (CN); Qingpeng XIE, Shenzhen (CN); Lina SUN, Shenzhen (CN)

(73) Assignee: HUAWEI TECHNOLOGIES CO., LTD., Shenzhen (CN)

(21) Appl. No.: 13/340,390

(22) Filed: Dec. 29, 2011

Related U.S. Application Data
(63) Continuation of application No. PCT/CN2011/078803, filed on Aug. 23, 2011.

(30) Foreign Application Priority Data
Jan. 24, 2011 (CN) 201110025963.3

(51) Int. Cl. H04H 60/32; H04L 12/26

(52) U.S. Cl. 725/14

(57) ABSTRACT

A Quality of Experience (QoE) ensuring method is disclosed. The method includes obtaining a QoE parameter of a media data stream, judging whether QoE of the media data stream will deteriorate according to the QoE parameter of the media data stream, and adjusting QoS of the media data stream to ensure the QoE if a judgment result shows that the QoE of the media data stream will deteriorate. By using the QoE ensuring method provided herein, whether the QoE will deteriorate can be judged beforehand, and the QoS is adjusted before the QoE deteriorates. In this way, preventive measures may be taken against possible deterioration of the QoE and the user's QoE is ensured.

### CROSS-REFERENCE TO RELATED APPLICATIONS

This application is a continuation of International Application No. PCT/CN2011/078803, filed on Aug. 23, 2011, which claims priority to Chinese Patent Application No. 201110025963.3, filed on Jan. 24, 2011, both of which are hereby incorporated by reference in their entireties.

### FIELD OF THE INVENTION

The present invention relates to the field of network management, and in particular, to a QoE ensuring method and an apparatus.

### BACKGROUND OF THE INVENTION

In network application, the network provider and the service provider generally care about quality of the Internet Protocol Television (IPTV) service received by the user. The traditional Quality of Service (QoS) parameter does not reflect the user experience intuitively. To reflect the user experience on the IPTV service more directly, the Quality of Experience (QoE) parameter emerges accordingly. The network provider and the service provider deploy measuring points (Measuring Points) in key places of the IPTV service transmission network, and integrate the algorithm of calculating the QoE value into the measuring points. A measuring point detects the required data, and obtains the QoE value of this point through the QoE algorithms.

In the process of developing the present invention, the inventor discovered that, by using the QoE ensuring method in the prior art, the corresponding QoS adjustment policy is used to ensure the QoE only when the play of the media data stream receiver is faulty, the user experience deteriorates, and the receiver reports the buffer information. However, in this case, the QoE deterioration on the receiver impacts the multimedia play watched by the user and therefore negatively impacts the user experience.

### SUMMARY OF THE INVENTION

An embodiment of the present invention provides a method and an apparatus for ensuring QoE. A QoE ensuring method includes: obtaining a QoE parameter of a media data stream, where the QoE parameter indicates receiver performance that affects quality of playing the media data stream;

judging the quality of playing the media data stream according to the QoE parameter, and judging whether QoE of the media data stream will deteriorate; and

adjusting QoS of the media data stream to ensure the QoE if a judgment result shows that the QoE of the media data stream will deteriorate.

A QoE ensuring apparatus includes:

a parameter obtaining unit, configured to obtain a QoE parameter of a media data stream;

a QoE judging unit, configured to analyze the QoE parameter of the media data stream and judge whether QoE of the media data stream will deteriorate according to the QoE parameter of the media data stream; and

a QoS adjusting unit, configured to adjust QoS of the media data stream to ensure the QoE if a judgment result shows that the QoE of the media data stream will deteriorate.

In the method for ensuring the QoE in the embodiments of the present invention, the QoE parameter of the media data stream is obtained, a judgment is made beforehand to know whether the QoE will deteriorate according to the QoE parameter of the media data stream, and the QoS is adjusted before the QoE deteriorates. In this way, preventive measures are taken against possible deterioration of the QoE, and the user QoE is ensured.

### BRIEF DESCRIPTION OF THE DRAWINGS

FIG. 1 is a flowchart of a QoE ensuring method according to an embodiment of the present invention;

FIG. 2 is a flowchart of a QoE ensuring method according to an embodiment of the present invention;

FIG. 3 is a flowchart of a QoE ensuring method according to an embodiment of the present invention;

FIG. 4 is a partial flowchart of a QoE ensuring method shown in FIG. 3;

FIG. 5 is a flowchart of a QoE ensuring method according to an embodiment of the present invention;

FIG. 6 is a QoE ensuring apparatus according to an embodiment of the present invention;

FIG. 7 is a QoE ensuring apparatus according to another embodiment of the present invention;

FIG. 8 is a QoE ensuring apparatus according to another embodiment of the present invention; and

FIG. 9 is a QoE ensuring apparatus according to another embodiment of the present invention.

### DETAILED DESCRIPTION OF THE EMBODIMENTS

An embodiment of the present invention provides a QoE ensuring method to ensure QoE for a terminal user when the terminal user accesses media content from a service provider or content provider. The method in this embodiment includes:

obtaining a QoE parameter of a media data stream, where the QoE parameter indicates receiver performance that affects quality of playing the media data stream;

judging the quality of playing the media data stream according to the QoE parameter, and judging whether QoE of the media data stream will deteriorate; and

adjusting QoS of the media data stream to ensure the QoE if a judgment result shows that the QoE of the media data stream will deteriorate.

In the method for ensuring the QoE in this embodiment, the QoE parameter of the media data stream is obtained, a judgment is made beforehand to know whether the QoE will deteriorate according to the QoE parameter of the media data stream, and the QoS is adjusted before the QoE deteriorates. In this way, preventive measures are taken against possible deterioration of the QoE, and therefore the user QoE is ensured.

The following describes a QoE ensuring method in detail through a specific embodiment with reference to an accompanying drawing.

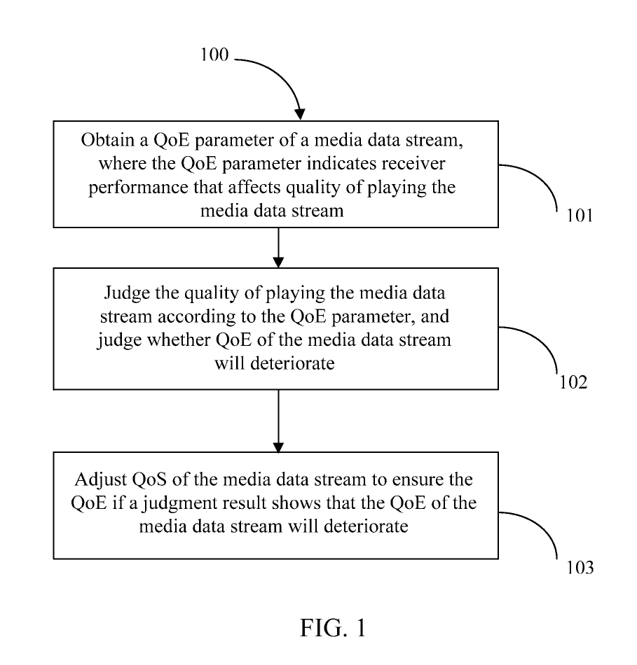

As shown in FIG. 1, an embodiment of the present invention provides a QoE ensuring method 100. The QoE ensuring method in this embodiment is applicable in an Http Stream scenario. In this scenario, for a user, QoE deterioration is primarily reflected by a pause of a media data stream, and the QoE deterioration is primarily manifested in a pause in the process of playing the media data stream. The main cause for the pause lies in decrease of network traffic of the media data stream received by the media data stream receiver and decrease of the data volume readable to the media data stream receiver, namely, buffer depth of the receiver.

An embodiment of the present invention provides a QoE ensuring method in which whether the QoE of the media data stream will deteriorate is judged by monitoring change of a buffer of a receiver. The method in this embodiment includes the following steps:

101. Obtain a QoE parameter of a media data stream, where the QoE parameter indicates receiver performance that affects quality of playing the media data stream.

The main objective of the step is to obtain a type of parameter, namely, the QoE parameter of the media data, which reflects whether the QoE will deteriorate. The QoE parameter indicates the receiver performance that affects quality of playing the media data stream. The QoE parameter of the media data stream may be sent by the client to a QoE monitoring server proactively, or sent by the client to the QoE monitoring server in response to a request sent by the QoE monitoring server.

To identify the media data stream, the method further includes receiving IP quintuple information or MAC triplet information sent by the media data stream receiver and determining the media data stream according to the IP quintuple information or MAC triplet information, where the obtaining the QoE parameter of the media data stream refers to: obtaining the QoE parameter of the determined media data stream. After the media data stream received by the receiver is determined, the QoE parameter of the media data stream can be obtained as required.

The IP quintuple information includes information on IP addresses of the media server and the terminal user, information that is on the source port number of the media service and is provided by the media service, information on the port number of the receiver that receives the media service, and information on the protocol type of the receiver. The MAC triplet information includes a source address of the media service, an address (target address) of the receiver that receives the media service, and a protocol type of the receiver. The QoE monitoring server records the IP quintuple information and the MAC triplet information sent by the receiver that receives the media service, and establishes, according to the IP quintuple information and the MAC triplet information, a correlation between the receiver and the media data stream received by the receiver, and therefore, the QoE monitoring server of the media data stream can identify the receiver that is receiving the media service and monitor the media data stream being received by the receiver of the media data stream.

102. Judge the quality of playing the media data stream according to the QoE parameter, and judge whether QoE of the media data stream will deteriorate.

In this step, the QoE server judges the quality of playing the media data stream according to the QoE parameter. The quality of playing the media data stream reflects variation of the QoE. Specifically, in an embodiment of the present invention, the QoE parameter includes the buffer status of the receiver, namely, buffer depth (Buffer Status: Measurement period buffer depth), which is the data volume readable by the media data stream receiver. Obtaining the QoE parameter of the media data stream includes: obtaining the buffer depth sent periodically by the media data stream receiver. Accordingly, step 102 may be: Analyzing the buffer depth, and determining that the QoE of the media data stream will deteriorate if the buffer depth decreases to a depth less than a threshold.

In this step, the QoE monitoring server analyzes and obtains the variation of the buffer of the receiver according to the buffer depth sent periodically by the receiver. Because the receiver sends its buffer status periodically and the variation of the buffer of the receiver may be regarded as regular in a certain time interval. Therefore, the QoE monitoring server can obtain the trend of the buffer by analyzing the buffer depth sent by the receiver in a certain time segment. The trend of the buffer reflects the quality of playing the media data stream. When the buffer depth of the receiver keeps decreasing, the buffer depth is compared with a threshold, and if the buffer depth of the receiver decreases to less than the threshold, it is considered that the buffer of the receiver will underflow in a future time segment. Specifically, if the buffer depth sent by the receiver keeps decreasing, it indicates that the media data volume readable in the buffer in the receiver keeps decreasing in a specific time segment. Moreover, when the media data volume in the buffer decreases to the threshold, if the QoS is not adjusted, the media data in the buffer will underflow after a future time segment, which will lead to a pause of playing the media data stream on the receiver and deteriorate the QoE. In this step, the memory status of the receiver is monitored in real time, and a judgment is made, and therefore, the QoS of the media data stream can be adjusted properly in subsequent steps according to the judgment result to ensure the QoE of the receiver.

103. Adjust QoS of the media data stream to ensure the QoE if the judgment result shows that the QoE of the media data stream will deteriorate.

In this step, the QoE monitoring server decides whether to adjust the QoS according to the judgment result. Specifically, this step may be:

Adjust the QoS of the media data stream received by the receiver if determining that the media play on the receiver will pause.

In this step, if the QoE monitoring server determines that the media play on the receiver will pause under the current QoS condition, which will lead to deterioration of the QoE, the server adjusts the QoS in real time to prevent the pause of the media play on the receiver and ensure the QoE. The QoS may be adjusted by increasing the transmission level of the media data stream received by the receiver and/or reducing the waiting delay of queuing and/or reducing the probability of being discarded proactively and/or increasing the transmitting power. The QoS adjustment may be implemented through a media server, or through interaction between QoE probes that are deployed in a distributed way.

In the QoE ensuring method in this embodiment, the variation of the buffer is used as a basis for judging whether the media data stream will pause in the play process. In this way, it is determined beforehand whether the media data stream received by the media data stream receiver will pause in the play process. If the pause will occur, the QoS is adjusted before occurrence of the pause, which prevents the QoE deterioration caused by the QoS deterioration.

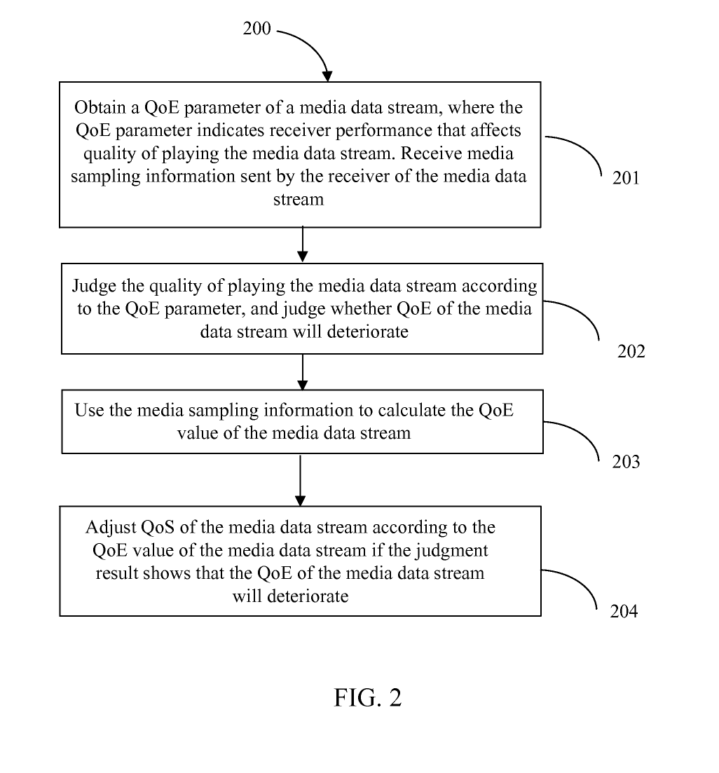

As shown in FIG. 2, another embodiment of the present invention provides a QoE ensuring method 200. Some steps of this method are the same as some steps in the QoE ensuring method 100 provided in the first embodiment above. The same steps are based on the same execution mechanism, and therefore are not repeated in this embodiment any further. As shown in FIG. 2, a QoE ensuring method 200 provided in this embodiment includes the following steps:

201. Obtain a QoE parameter of a media data stream, where the QoE parameter indicates receiver performance that affects quality of playing the media data stream. Receive media sampling information sent by the receiver of the media data stream.

This step differs from step 101 in that: The media sampling information of the media data stream needs to be obtained. The media sampling information includes: codec information (Codec Information), a codec image size (Codec Image Size), a bit rate (Bitrate), and a frame rate (Framerate). The main objective of obtaining the media sampling information is to use the media sampling information to calculate the QoE value of the media data stream so that the QoS can be adjusted more accurately when the QoE is going to deteriorate.

202. Judge the quality of playing the media data stream according to the QoE parameter, and judge whether QoE of the media data stream will deteriorate.

203. Use the media sampling information to calculate the QoE value of the media data stream.

This step 203 is different from the counterpart step in the QoE ensuring method 100. The main objective of this step is to use the QoE value as a reference to adjust the QoS subsequently so that the adjustment is more accurate.

204. Adjust QoS of the media data stream according to the QoE value of the media data stream if a judgment result shows that the QoE of the media data stream will deteriorate.

In this step, the QoE monitoring server adjusts the QoS according to the QoE value when determining that the QoE will deteriorate. Specifically, adjusting the QoS according to the QoE value may be as follows: The QoE may be divided into multiple ranges, and each range corresponds to a different adjustment level. If the QoE of the media data stream falls within a preset range, a corresponding QoS adjustment may be performed. Therefore, the QoS adjustment is more accurate and reliable.

By using the QoE ensuring method in this embodiment, whether the QoE will deteriorate is judged beforehand, and the QoS is adjusted before the QoE deteriorates. In this way, preventive measures are taken against possible deterioration of the QoE, and therefore the user QoE is ensured.

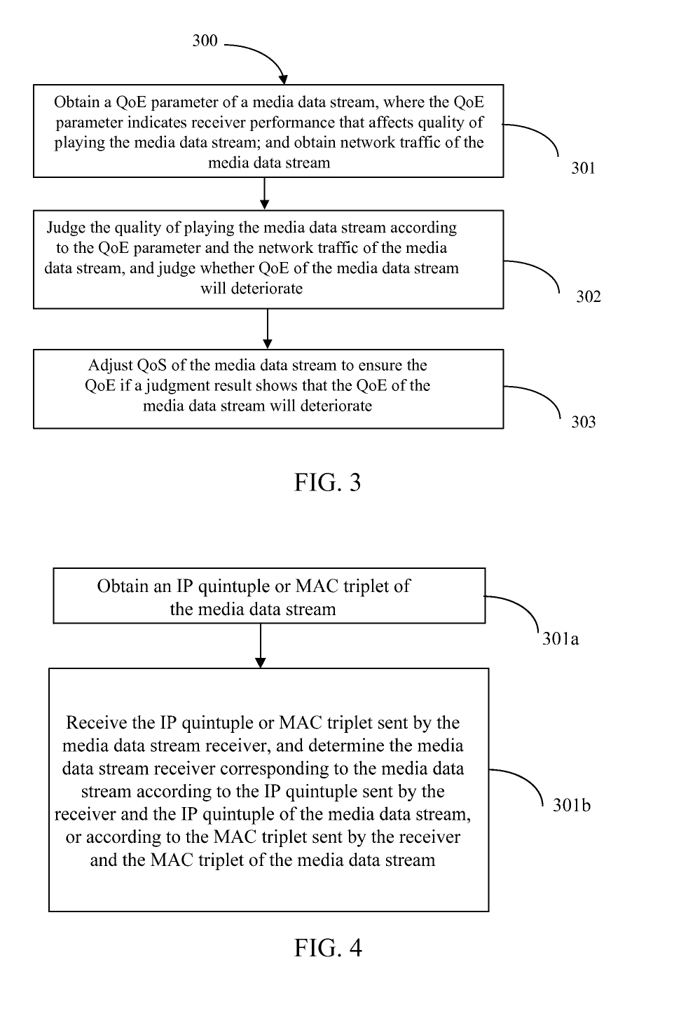

As shown in FIG. 3, an embodiment of the present invention provides a QoE ensuring method 300. In the method 300, the QoE is ensured by obtaining the traffic of the media data stream and the QoE parameter. Specifically, the method is applicable in a scenario in which a QoE probe is set on the network element side. The QoE probe refers to a network probe for probing network traffic. The QoE ensuring method 300 includes the following steps:

301. Obtain a QoE parameter of a media data stream, where the QoE parameter indicates receiver performance that affects quality of playing the media data stream; and obtain network traffic of the media data stream.

Specifically, in this step, the QoE parameter of the media data stream includes initial buffer depth of the receiver, and therefore, obtaining the QoE parameter of the media data stream includes: obtaining the buffer depth sent by the receiver of the media data stream and the network traffic sent periodically by a QoE probe in the path of the media data stream.

To judge whether the QoE will deteriorate according to the network traffic, the QoE monitoring server needs to know the buffer depth of the client. If the QoE server obtains the buffer depth, the QoE server can deduce variation of the buffer of the client at a specific time point according to the obtained network traffic, and judge whether the QoE will deteriorate. The network traffic is sent periodically by a QoE probe set in the path of the media data stream. In addition, it should be noted that the buffer depth may vary at different time points. Therefore, if receiving the initial buffering (Initial buffering) of the receiver, the QoE monitoring server records the buffer depth after the initial pause of the receiver; if receiving the rebuffering (Rebuffering) of the receiver, the QoE monitoring server records the buffer depth after a pause of the receiver.

Further, as shown in FIG. 4, to establish a definite relationship between the receiver of the media service and the media data stream probed by a network probe, the method may include the following steps before step 301:

301a. Obtain an IP quintuple or MAC triplet of the media data stream.

In this step, the monitoring server monitors the network data stream through a QoE probe. If a data stream is determined as a media data stream, the IP quintuple or MAC triplet of the media data stream is sent to the monitoring server. In this embodiment, the media data stream is monitored by a QoE probe. The QoE probe is deployed on a network element side, and monitors the data streams of network elements on which the QoE probe is deployed. If detecting that a data stream in the network element is a media data stream, the QoE probe on the network element records the IP quintuple or MAC triplet of the media data stream, and sends the IP quintuple or MAC triplet to the QoE monitoring server. In this way, a monitoring object is determined.

301b. Receive the IP quintuple or MAC triplet sent by the media data stream receiver, and determine the media data stream receiver corresponding to the media data stream according to the IP quintuple sent by the receiver and the IP quintuple of the media data stream, or according to the MAC triplet sent by the receiver and the MAC triplet of the media data stream.

In this step, the QoE monitoring server establishes a correlation between the media data stream sent by the QoE probe of the media data stream and the corresponding receiver according to the IP quintuple or MAC triplet of the media data stream sent by the QoE probe, and according to the IP quintuple or MAC triplet sent by the receiver that receives a media service. In this way, it is ensured that a correct media data stream monitoring link can be set up.

302. Judge the quality of playing the media data stream according to the QoE parameter and the network traffic of the media data stream, and judge whether QoE of the media data stream will deteriorate.

In this step, the QoE server judges whether the media data stream will deteriorate in the play process according to the QoE parameter and network traffic of the media data stream. Specifically, if the network traffic of the media data stream keeps being less than an average bit rate in a specific time segment, and, if the buffer depth of the receiver decreases and decreases to a depth less than a threshold, the QoE server determines that the buffer will underflow in a future time segment, which will lead to a pause and QoE deterioration. The network traffic and the buffer depth of the receiver are monitored in real time, and are used as a basis for judging whether the media play process of the receiver will pause. In this way, the judgment is more accurate, and the receiver does not need to send its buffer depth periodically.

303. Adjust QoS of the media data stream to ensure the QoE if the judgment result shows that the QoE of the media data stream will deteriorate.

Specifically, in this step, if determining that the media play process will pause, the QoE monitoring server adjusts QoS of the media data stream.

The embodiment provides a method by using which the traffic of the media data stream and the buffer depth of the receiver are probed by a QoE probe and are used as a basis for judging whether the media data stream will pause. In the method, the QoE probe monitors the time of the media data stream directly, and judges beforehand whether the media play process on the receiver will pause. If it is determined that the pause will occur, the QoS is adjusted to prevent QoE deterioration caused by the pause. In addition, in this embodiment, the QoS probe sends a media data stream, which reduces parameters sent by the receiver, and therefore relieves the load on the receiver, saves network resources, and improves the QoE status of the receiver.

In addition, an embodiment of the present invention provides a media service ensuring method 300. In this method, the functions such as judgment, calculation, and network QoS adjustment of the QoE monitoring server may be performed by a QoE probe, and the QoE monitoring server is responsible for receiving and sending information only. In addition, in this embodiment, the functions such as judgment, calculation, and network QoS adjustment of the QoE monitoring server are directly performed by a QoE monitoring network composed of QoE probes, without requiring any QoE monitoring server. The interaction between the QoE probes is implemented through a distributed network.

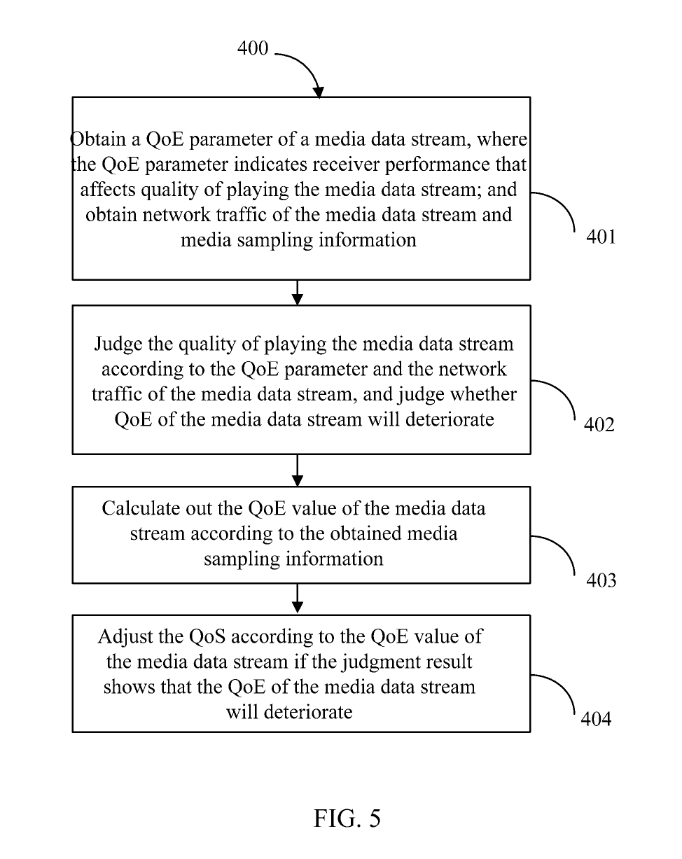

As shown in FIG. 5, an embodiment of the present invention provides another QoE ensuring method 400. Some steps of this method are the same as some steps in the QoE ensuring method 300 provided in the third embodiment above. The same steps are based on the same execution mechanism, and therefore are not repeated in this embodiment any further. The steps of this embodiment that are different from those in the QoE ensuring method 300 provided in the third embodiment are detailed below. A QoE ensuring method 400 provided in this embodiment includes the following steps:

401. Obtain a QoE parameter of a media data stream, where the QoE parameter indicates receiver performance that affects quality of playing the media data stream; and obtain network traffic of the media data stream and media sampling information.

This step differs from step 301 in that: The media sampling information of the media data stream needs to be obtained. The media sampling information includes: codec information (Codec Information), a codec image size (Codec Image Size), a bit rate (Bitrate), and a frame rate (Framerate).

402. Judge the quality of playing the media data stream according to the QoE parameter and the network traffic of the media data stream, and judge whether QoE of the media data stream will deteriorate.

403. Calculate the QoE value of the media data stream according to the obtained media sampling information. This step 403 is different from the counterpart step in the QoE ensuring method 300. The main objective of this step is to use the QoE value as a reference to adjust the QoS subsequently so that the adjustment is more accurate.

404. Adjust the QoS according to the QoE value of the media data stream if the judgment result shows that the QoE of the media data stream will deteriorate.

This step differs from step 303 in that the QoE monitoring server adjusts the QoS policy according to the QoE value when determining that the QoE will deteriorate. Specifically, adjusting the QoS policy according to the QoE value is as follows: The QoE may be divided into multiple grade ranges, and each grade range corresponds to a different QoE adjustment level. If the QoE of the media data stream falls within a preset range, a corresponding QoS adjustment may be performed. In this way, the QoS adjustment is more accurate and reliable.

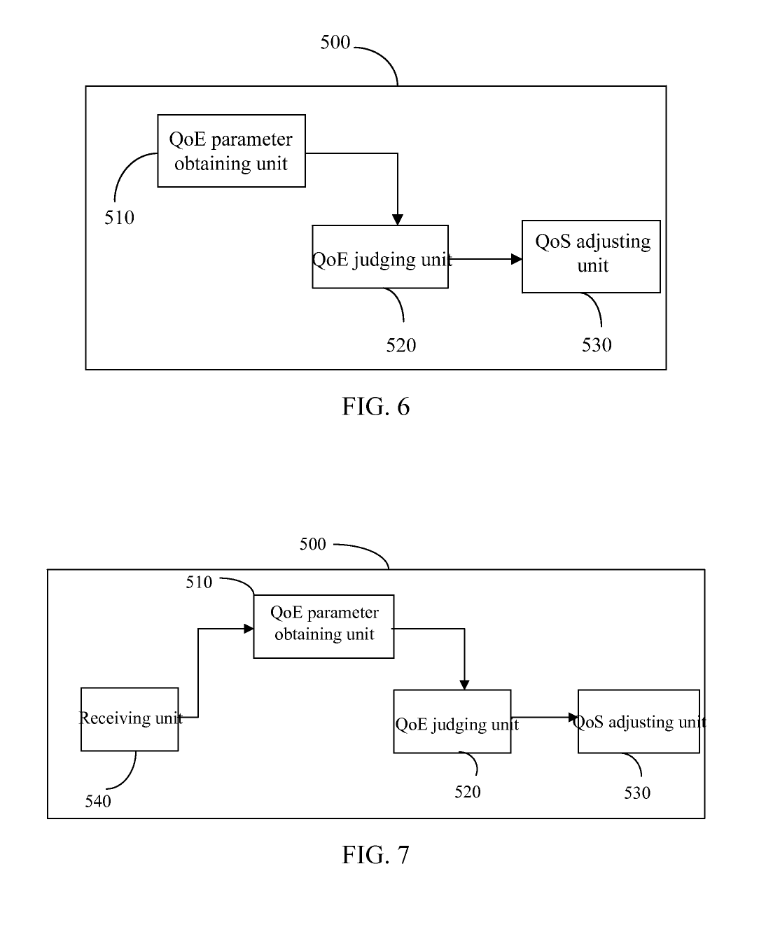

As shown in FIG. 6, an embodiment of the present invention provides a QoE ensuring apparatus 500. The apparatus ensures the QoE of a user when a terminal user obtains media content from a service provider or content provider. The apparatus may be integrated in a content provision server or network server. The QoE ensuring apparatus 500 can implement the method provided in the preceding embodiment, and includes a parameter obtaining unit 510, configured to obtain a QoE parameter of a media data stream; a QoE judging unit 520, configured to analyze the QoE parameter of the media data stream, and judge whether QoE of the media data stream will deteriorate according to the QoE parameter of the media data stream; and a QoS adjusting unit 530, configured to adjust QoS of the media data stream to ensure the QoE if a judgment result shows that the QoE of the media data stream will deteriorate.

As shown in FIG. 7, a QoE ensuring apparatus 500 further includes:

a receiving unit 540, configured to obtain IP quintuple information or MAC triplet information sent by the media data stream receiver, and determine the media data stream according to the IP quintuple information or MAC triplet information.

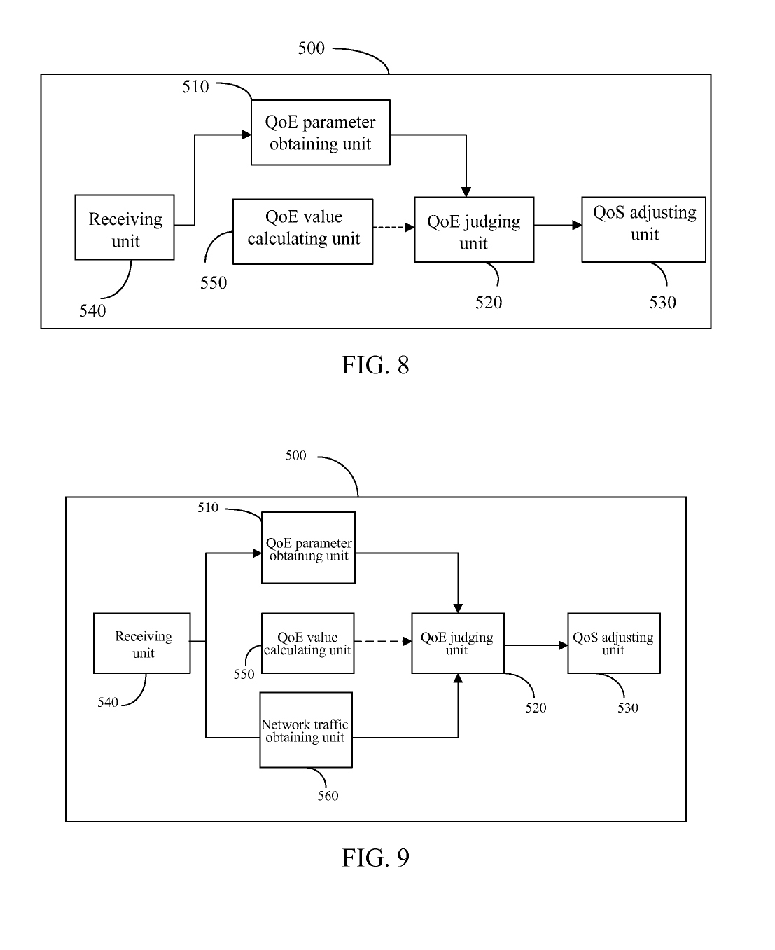

The parameter obtaining unit 510 is further configured to receive media sampling information sent by the media data stream receiver. Accordingly, as shown in FIG. 8, the QoE ensuring apparatus 500 further includes a QoE value calculating unit 550, configured to use the media sampling information to calculate the QoE value of the media data stream.

Accordingly, the QoS adjusting unit 530 is further configured to adjust QoS of the media data stream according to the QoE value.

Further, with respect to the parameter obtaining unit 510, the QoE parameter is the buffer depth of the media data stream receiver. Accordingly, the parameter obtaining unit is configured to obtain the buffer depth sent periodically by the media data stream receiver.

Accordingly, the QoE judging unit 520 is configured to analyze the buffer depth, and determine that the QoE will deteriorate if the buffer depth decreases to a depth less than a threshold.

As shown in FIG. 9, the QoE ensuring apparatus 500 further includes a network traffic obtaining unit 560, configured to obtain network traffic of the media data stream.

Accordingly, the QoE judging unit 520 is configured to judge whether QoE of the media data stream will deteriorate in the play process according to the QoE parameter of the media data stream and the network traffic of the media data stream.

Further, the receiving unit 540 is configured to obtain an IP quintuple information or MAC triplet information of the media data stream, receive the IP quintuple or MAC triplet sent by the media data stream receiver, and determine the media data stream receiver corresponding to the media data stream according to the IP quintuple sent by the receiver and the IP quintuple of the media data stream, or according to the MAC triplet sent by the receiver and the MAC triplet of the media data stream, and according to the IP quintuple or MAC triplet sent by the receiver and the IP quintuple or MAC triplet of the media data stream.

Further, the QoE parameter is the buffer depth of the media data stream receiver. Accordingly, the parameter obtaining unit is configured to obtain the buffer depth sent by the media data stream receiver; and the network traffic obtaining unit 560 is configured to obtain network traffic sent periodically by QoE probes.

Accordingly, the QoE judging unit 520 is configured to analyze the buffer depth and the network traffic, and determine that the buffer will underfiow in a future time segment to cause a pause and QoE deterioration if the network traffic of the media data stream is less than an average bit rate and the buffer depth of the media data stream receiver decreases to a depth less than a threshold.

The implementation mechanism of the QoE ensuring apparatus 500 provided in this embodiment is the same as the implementation mechanism of the QoE ensuring methods 100-400 provided above, and accomplishes the same technical effects. For details, refer to the QoE ensuring methods described above.

With the descriptions of implementation methods above, those skilled in the art are clearly aware that the embodiments of the present invention may be implemented through hardware only, or preferably, through software in addition to a necessary universal hardware platform. Therefore, the essence of the technical solution of the present invention or its contribution to the prior art may be embodied in a software product. The software product is stored in computer-readable storage media such as computer floppy disk, hard disk and CD-ROM, and incorporates several instructions for instructing a computer device (for example, personal computer, server, or network device) to execute the methods specified in any embodiment of the present invention.

What is claimed is:

1. A Quality of Experience (QoE) ensuring method, comprising:
obtaining a QoE parameter of a media data stream, wherein the QoE parameter indicates receiver performance that affects quality of playing the media data stream;
judging the quality of playing the media data stream according to the QoE parameter;
judging whether QoE of the media data stream will deteriorate; and
adjusting Quality of Service (QoS) of the media data stream to ensure the QoE if a judgment result shows that the QoE of the media data stream will deteriorate.

2. The QoE ensuring method according to claim 1, wherein: before the obtaining the QoE parameter of the media data stream, the method further comprises:
receiving IP quintuple information or MAC triplet information sent by a media data stream receiver, and determining a media data stream according to the IP quintuple information or MAC triplet information,
wherein the obtaining the QoE parameter of the media data stream refers to obtaining the QoE parameter of the determined media data stream.

3. The QoE ensuring method according to claim 1, further comprising:
receiving media sampling information sent by a media data stream receiver and using the media sampling information to calculate a QoE value of the media data stream, wherein the adjusting the QoS of the media data stream to ensure the QoE comprises adjusting the QoS of the media data stream according to the QoE value of the media data stream.

4. The QoE ensuring method according to claim 2, wherein:
the QoE parameter comprises buffer depth of the media data stream receiver,
the obtaining the QoE parameter of the media data stream comprises obtaining the buffer depth sent periodically by the media data stream receiver, and
the judging whether the QoE of the media data stream will deteriorate according to the QoE parameter of the media data stream comprises analyzing the buffer depth and determining that the QoE of the media data stream will deteriorate if the buffer depth decreases to a depth less than a threshold.

5. The QoE ensuring method according to claim 1, further comprising:
obtaining network traffic of the media data stream, wherein
the judging whether the QoE of the media data stream will deteriorate according to the QoE parameter of the media data stream comprises judging whether the QoE of the media data stream will deteriorate according to the QoE parameter of the media data stream and the network traffic of the media data stream.

6. The QoE ensuring method according to claim 5, further comprising:
receiving media sampling information sent by a media data stream receiver; and
using the media sampling information to calculate a QoE value of the media data stream, wherein
the adjusting the QoS of the media data stream to ensure the QoE comprises adjusting the QoS according to the QoE value of the media data stream.

7. The QoE ensuring method according to claim 5, wherein:
the QoE parameter comprises buffer depth of the media data stream receiver,
the obtaining the QoE parameter of the media data stream comprises obtaining the buffer depth sent by the media data stream receiver,
the obtaining the network traffic of the media data stream comprises receiving the network traffic sent periodically by a QoE probe in a path of the media data stream, and
the judging whether the QoE of the media data stream will deteriorate according to the QoE parameter of the media data stream comprises analyzing the network traffic according to the buffer depth and determining that the QoE will deteriorate if the network traffic of the media data stream is less than an average bit rate and the buffer depth of the media data stream receiver decreases to a depth less than a threshold.

8. A QoE ensuring apparatus, comprising:
a parameter obtaining unit configured to obtain a QoE parameter of a media data stream, wherein the QoE parameter indicates receiver performance that affects quality of playing the media data stream;
a QoE judging unit configured to judge the quality of playing the media data stream according to the QoE parameter and to judge whether QoE of the media data stream will deteriorate; and
a QoS adjusting unit configured to adjust QoS of the media data stream to ensure the QoE if a judgment result shows that the QoE of the media data stream will deteriorate.

9. The QoE ensuring apparatus according to claim 8, further comprising:
a receiving unit configured to receive IP quintuple information or MAC triplet information sent by a media data stream receiver and to determine a media data stream according to the IP quintuple information or MAC triplet information, wherein
the parameter obtaining unit obtaining the QoE parameter of the media data stream refers to obtaining the QoE parameter of the determined media data stream.

10. The QoE ensuring apparatus according to claim 8, wherein:
the parameter obtaining unit is further configured to receive media sampling information sent by the media data stream receiver,
the QoE judging unit further comprises a QoE value calculating unit configured to use the media sampling information to calculate a QoE value of the media data stream, and
the QoS adjusting unit is configured to adjust QoS of the media data stream according to the QoE value of the media data stream.

11. The QoE ensuring apparatus according to claim 9, wherein:
the QoE parameter is buffer depth of the media data stream receiver,
the parameter obtaining unit is configured to obtain the buffer depth sent periodically by the media data stream receiver, and
the QoE judging unit is configured to analyze the buffer depth and to determine that the QoE will deteriorate if the buffer depth decreases to a depth less than a threshold.

12. The QoE ensuring apparatus according to claim 8, further comprising:
a network traffic obtaining unit configured to obtain network traffic of the media data stream, wherein
the QoE judging unit is configured to judge whether QoE of the media data stream will deteriorate according to the QoE parameter of the media data stream and the network traffic of the media data stream.

13. The QoE ensuring apparatus according to claim 12, wherein:
the parameter obtaining unit is further configured to receive media sampling information sent by the media data stream receiver,
the QoE judging unit further comprises a QoE value calculating unit configured to use the media sampling information to calculate a QoE value of the media data stream, and
the QoS adjusting unit is configured to adjust QoS of the media data stream according to the QoE value of the media data stream.

14. The QoE ensuring apparatus according to claim 12, wherein:
the QoE parameter is buffer depth of the media data stream receiver,
the parameter obtaining unit is configured to obtain the buffer depth sent by the media data stream receiver,
the network traffic obtaining unit is configured to obtain the network traffic sent periodically by QoE probes, and
the QoE judging unit of the media data stream is configured to analyze the buffer depth and the network traffic and to determine that the QoE will deteriorate if the network traffic of the media data stream is less than an average bit rate and the buffer depth of the media data stream receiver decreases to a depth less than a threshold.

15. A computer readable storage medium having instructions for performing the method of ensuring quality of Experience (QoE) comprising:
obtaining a QoE parameter of a media data stream, wherein the QoE parameter indicates receiver performance that affects quality of playing the media data stream;
judging the quality of playing the media data stream according to the QoE parameter;
judging whether QoE of the media data stream will deteriorate; and
adjusting Quality of Service (QoS) of the media data stream to ensure the QoE if a judgment result shows that the QoE of the media data stream will deteriorate.

16. The computer readable storage medium according to claim 15, wherein: before the obtaining the QoE parameter of the media data stream, the method further comprises:
receiving IP quintuple information or MAC triplet information sent by a media data stream receiver and determining a media data stream according to the IP quintuple information or MAC triplet information, wherein the obtaining the QoE parameter of the media data stream refers to obtaining the QoE parameter of the determined media data stream.

17. The computer readable storage medium according to claim 15, further comprising:
receiving media sampling information sent by a media data stream receiver, and
using the media sampling information to calculate a QoE value of the media data stream, wherein
the adjusting the QoS of the media data stream to ensure the QoE comprises adjusting the QoS of the media data stream according to the QoE value of the media data stream.

18. The computer readable storage medium to claim 16, wherein:
the QoE parameter comprises buffer depth of the receiver,
the obtaining the QoE parameter of the media data stream comprises obtaining the buffer depth sent periodically by the media data stream receiver, and
the judging whether the QoE of the media data stream will deteriorate according to the QoE parameter of the media data stream comprises analyzing the buffer depth and determining that the QoE of the media data stream will deteriorate if the buffer depth decreases to a depth less than a threshold.

19. The computer readable storage medium according to claim 15, further comprising:
obtaining network traffic of the media data stream,
wherein the judging whether the QoE of the media data stream will deteriorate according to the QoE parameter of the media data stream comprises judging whether the QoE of the media data stream will deteriorate according to the QoE parameter of the media data stream and the network traffic of the media data stream.

20. The computer readable storage medium according to claim 19, further comprising:
receiving media sampling information sent by the media data stream receiver; and
using the media sampling information to calculate a QoE value of the media data stream,
wherein the adjusting the QoS of the media data stream to ensure the QoE comprises: adjusting the QoS according to the QoE value of the media data stream.
